(19) United States
(12) Patent Application Publication
(10) Pub. No.: US 2015/0160906 A1
(43) Pub. Date: Jun. 11, 2015

(54) INTERFACE AND DISPLAY CONNECTED TO THE SAME

(71) Applicant: SAMSUNG DISPLAY CO., LTD., Yongin-City (KR)

(72) Inventor: Kyung Ho HWANG, Chungcheongnam-do (KR)

(21) Appl. No.: 14/338,833

(22) Filed: Jul. 23, 2014

(30) Foreign Application Priority Data
Dec. 6, 2013 (KR) 10-2013-0151835

(51) Int. Cl. G06F 3/14

(52) U.S. Cl. CPC G06F 3/1407; G09G 2370/10; G09G 2370/14

(57) ABSTRACT

An interface includes a transmitter to transmit and receiver. The transmitter transmits data and a clock signal through data and clock signal lanes, respectively. The receiver receives the data and clock signal. The transmitter periodically inserts a high speed data transmission (HSDT) entering sequence into the clock signal.

### CROSS-REFERENCE TO RELATED APPLICATION

Korean Patent Application No. 10-2013-0151835, filed on Dec. 6, 2013, and entitled, “Interface and Display Connected to the Same,” is incorporated by reference herein in its entirety.

### BACKGROUND

1. Field

One or more embodiments described herein relate to a display interface and display connected to the same.

2. Description of the Related Art

Mobile industry processor interface (MIPI) standards have been proposed. MIPI standards process high-speed transmission of large capacity data with low power consumption between a display and central processing unit. When the display is driven and electrostatic discharge (ESD) noise is applied to an MIPI clock signal, images may be stopped or broken. Also, when ESD is applied to an MIPI lane in HS mode, a display driving IC may switch to LP mode. However, the set is operated in HS Mode and does not communicate with the display driving IC. As a result, the images are stopped or broken.

### SUMMARY

In accordance with one or more embodiment, an interface includes a transmitter to transmit data and a clock signal through a data lane and a clock signal lane, respectively; and a receiver to receive the data and clock signal, wherein the transmitter may periodically insert a high speed data transmission (HSDT) entering sequence into the clock signal. The transmitter may insert the HSDT entering sequence into a porch period of the clock signal.

The clock signal may include first and second clock signals, and the HSDT entering sequence may include periods distinguishable by a combination of a level of the first clock signal and a level of the second clock signal. The HSDT entering sequence may includes a plurality of periods distinguishable by a combination of a first level of the first clock signal and a first level of the second clock signal, a second level of the first clock signal and the first level of the second clock signal, and the second level of the first clock signal and a second level of the second clock signal.

In accordance with another embodiment, an interface includes a transmitter to transmit data and a clock signal through a data lane and a clock signal lane, respectively; and a receiver to receive the data and clock signal, wherein the receiver is to transmit an error signal that corresponds to a detected status error to the transmitter, and the transmitter is to insert a high speed data transmission (HSDT) entering sequence into the clock signal when detected by the error signal.

The clock signal may include first and second clock signals, and the HSDT entering sequence may include periods distinguishable by a combination of a level of the first clock signal and a level of the second clock signal. The HSDT entering sequence may include a plurality of periods distinguishable by a combination of a first level of the first clock signal and a first level of the second clock signal, a second level of the first clock signal and the first level of the second clock signal, and the second level of the first clock signal and a second level of the second clock signal.

In accordance with another embodiment, an interface includes a transmitter to set a lock register to indicate one of a high speed mode or a low power mode, and to transmitting the lock register value with data and a clock signal through a data lane and a clock signal lane, respectively; and a receiver to receive the data and clock signal, to recognize a transmission mode according to the lock register value, and to determine validity of the received data.

When switching to the high speed mode from the low power mode, the transmitter may start high-speed data transmission, set the lock register value to a value indicating the high-speed mode, and transmit a signal corresponding to the predetermined lock register value to the receiver. The receiver may recognize the high-speed mode according to a signal corresponding to the predetermined lock register value, and may determine the data received by the high-speed data transmission to be valid data.

When switching to the low power mode from the high-speed mode, the transmitter may set the lock register value to be a value indicating the low power mode, and to transmit a signal that corresponds to the predetermined lock register value to the receiver. The receiver may recognize the low power mode according to a signal corresponding to the predetermined lock register value, and determine that the data received by the low power data transmission is valid data.

In accordance with another embodiment, a display for receiving data and a clock signal from a set through an interface includes a signal controller to generate an image data signal and a data driving control signal from the data and clock signal; and a data driving circuit to generate a plurality of data voltages based on the image data signal and data driving control signal, wherein the clock signal includes a high speed data transmission (HSDT) entering sequence. The entering sequence may be periodically inserted into the clock signal.

The signal controller may include a receiver to transmit an error signal corresponding to the detected status error to a transmitter of the interface, and the HSDT entering sequence may be inserted into the clock signal when the error signal is transmitted.

In accordance with another embodiment, an interface includes a transmitter to transmit data and a clock signal through a data lane and a clock signal lane, respectively, wherein: the transmitter is to insert an entering sequence into the clock signal, the clock signal includes first and second clock signals, and the entering sequence includes periods distinguishable based on levels of the first and second clock signals in each of the periods.

The clock signals may form a differential clock signal. The first and second clock signals may have a same level in a first section of a porch period and different levels in a second section of a porch period. The second section of the porch period may be longer than the first section of the porch period. The entering sequence may be a high-speed data transmission entering sequence.

### BRIEF DESCRIPTION OF THE DRAWINGS

Features will become apparent to those of skill in the art by describing in detail exemplary embodiments with reference to the attached drawings in which:

FIG. 1 illustrates an embodiment of an interface;

FIG. 2 illustrates insertion of an HSDT sequence according to one embodiment;

FIG. 3 illustrates another embodiment of an interface;

FIG. 4 illustrates an example of a table for status errors;

FIG. 5 illustrates another embodiment of a interface; and

FIG. 6 illustrates a set and a display connected through an interface according to one embodiment.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

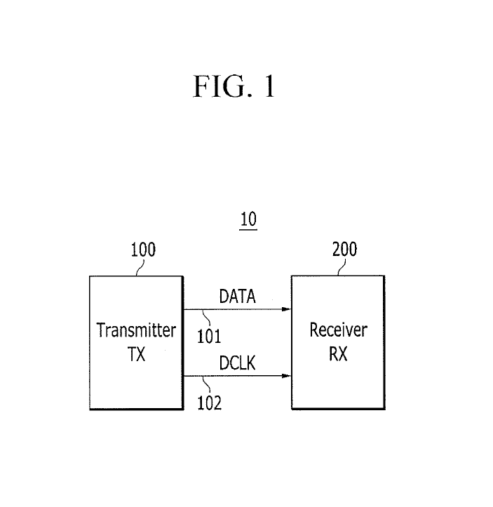

FIG. 1 shows an embodiment of an interface 10 which includes a transmitter 100 and a receiver 200. The transmitter 100 transmits data (DATA) and a clock signal (DCLK) to the receiver. In one embodiment, the transmitter periodically inserts a high speed data transmission (HSDT) entering sequence into the clock signal (DCLK), and transmits the same to the receiver. The receiver 200 demodulates the data (DATA) and clock signal (DCLK) to generate information.

The transmitter 100 transmits the data (DATA) to the receiver 200 through a data lane 101, which, for example, may include at least one pair of differential lanes. The data (DATA) may include at least one pair of differential signals. A difference between the pair of differential signals corresponds to information.

When the data (DATA) includes image information, the receiver 200 may be in a display. The receiver 200 demodulates the data (DATA) to generate image information.

The transmitter 100 transmits the clock signal (DCLK) to the receiver 200 through clock signal lane 102. The clock signal lane 102 may be two differential lanes. The clock signal (DCLK) includes two differential signals, and a difference between the two differential signals corresponds to information.

When the receiver 200 is in the display, information shown by the clock signal (DCLK) may include timing information. The receiver 200 demodulates the clock signal (DCLK) to generate a timing signal, which, for example, may include a vertical synchronization signal and a horizontal synchronization signal for displaying image information. For example, the transmitter 100 may insert an HSDT entering sequence in a porch period of the clock signal (DCLK).

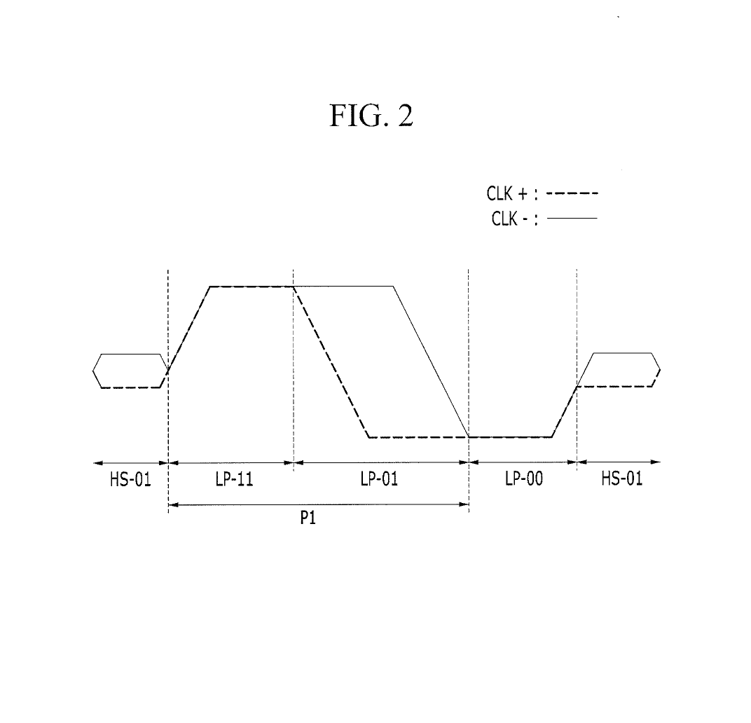

FIG. 2 shows a waveform diagram of insertion of an HSDT sequence according to one embodiment. Clock signals (DCLK) in FIG. 2 include two differential clock signals (CLK+, CLK−). The clock signal (DCLK) is transmitted in a high speed (HS) mode, and may periodically include an HSDT entering sequence in a porch period. In the porch period (P1) of clock signal (DCLK), the clock signal (DCLK) is transmitted in a low power (LP) mode.

The HSDT entering sequence includes a period of LP-11 in which the clock signal (CLK+) and clock signal (CLK−) are a high-level, a period of LP-01 in which the clock signal (CLK+) is at a low-level and clock signal (CLK−) is at a high-level, and a period of LP-00 in which clock signals (CLK+) and (CLK−) are at a low-level.

The clock signal (DCLK) is transmitted in the HS mode before and after the porch period (P1). For example, the period of HS-01 according to the HS mode is provided before the porch period (P1). The period of HS-01 according to the HS mode is provided after the porch period (P1). A swing width and a frequency of clock signals (CLK+, CLK−) in the LP mode is different from a swing width and a frequency of clock signals (CLK+, CLK−) in the HS mode. It is therefore is easy to distinguish the two modes.

During periods LP-11, LP01, and LP-00 of the LP mode, the receiver 200 recognizes the signals in these periods as information for instructing the HS mode. The HS mode may be driven or maintained based on this information.

When the HS mode is switched to LP mode, for example, by external noise caused by ESD, the mode is again changed to the HS mode. The clock signal (DCLK) may include a forward porch and a back porch, and the HSDT entering sequence is inserted into at least one of the two porch periods.

An interface according to another embodiment will now be described. Instead of periodically inserting the HSDT entering sequence, the HSDT entering sequence is inserted when a status error of the interface is detected.

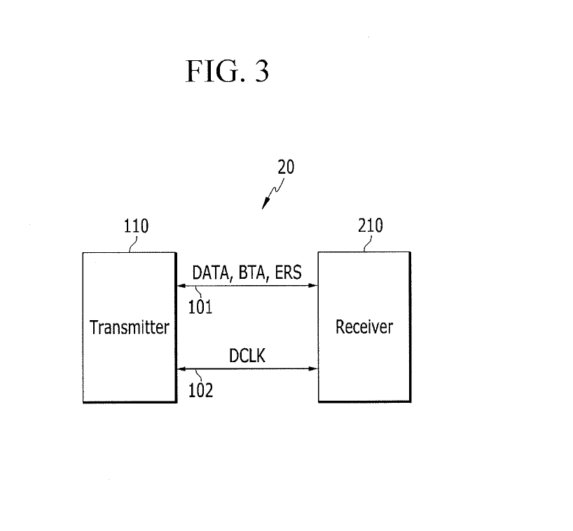

FIG. 3 shows another embodiment of an interface 20 which includes a transmitter 110 and a receiver 210. The transmitter 110 transmits a signal (BTA) for imparting a status report right to receiver 210 through a data lane 101. Upon receiving the signal (BTA), the receiver 210 transmits an error signal (ERS) that corresponds to the detected status error to the transmitter 110 through the data lane 101.

The signal (BTA) and error signal (ERS) may be transmitted and received in packet form together with the data (DATA). When an error signal (ERS) is detected, the transmitter 110 inserts the HSDT entering sequence into the clock signal (DCLK). In this instance, the error signal (ERS) may indicate a status error that occurs, for example, by external noise caused by the ESD.

The HSDT entering sequence may be a waveform of the clock signals (CLK+, CLK−) in porch period (P1) in FIG. 2. However, the HSDT entering sequence may not only be inserted into the porch period, but may also be inserted into clock signal (DCLK) in synchronization with a time when the status error is detected.

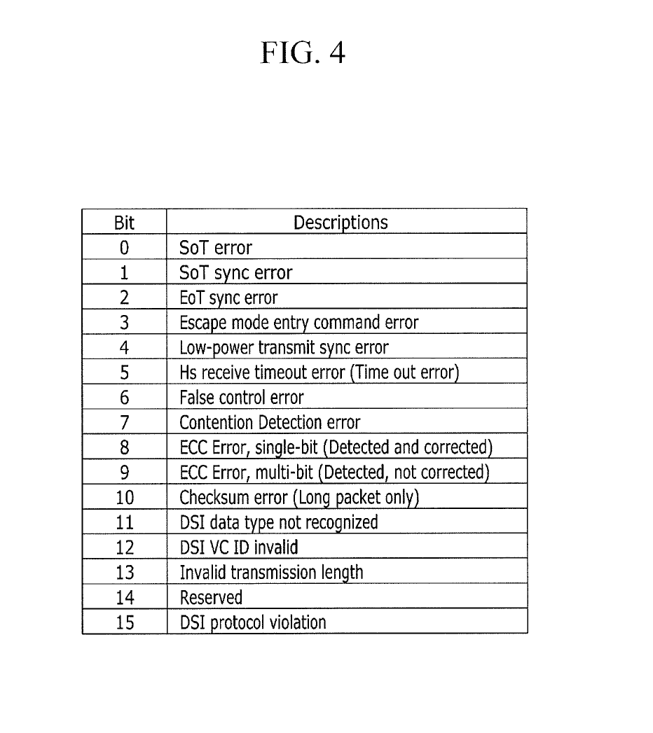

FIG. 4 shows a table of various types of status errors. In one embodiment, error signal (ERS) may be a 16-bit signal and the status error may be set to each bit. For example, a bit of an address 0 of the error signal (ERS) may indicate whether a start of transmission (SoT), and may represent an error that occurs when transmission is not performed, for example, by a protocol established by the MIPI alliance.

A bit of an address 1 of the error signal (ERS) may indicate whether a SoT Error is generated. (SoT Sync Error indicates an error when SoT Sync is not correct). When the status error that corresponds to the respective address is detected, the bit of the corresponding address is 1 and is 0 in the opposite case. As described, when a status error is generated in another embodiment, the HSDT entering sequence is inserted and HS mode is maintained.

In the other exemplary embodiment, an additional lock register may be set in the transmitter to instruct a mode presently selected between the HS mode and the LP mode. The lock register value may be included in one of the data or clock signal or in another signal transmitted through another lane. The lock register value may then be transmitted to the receiver.

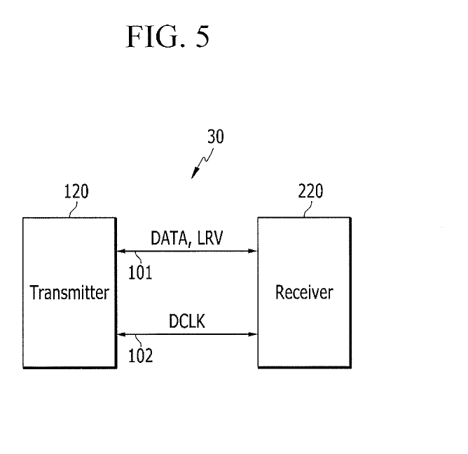

FIG. 5 shows an interface 30 according to another embodiment. In FIG. 5, an additional lane is provided and a signal including a lock register value is transmitted through a corresponding lane. As described above, the lock register may be included in the data (DATA) and the clock signal (DCLK).

The interface 30 includes a transmitter 120 and a receiver 220. A signal (LRV) for indicating a lock register value is transmitted in packet form to receiver 220 with the data (DATA) through the data lane 101. When the mode is switched to the HS mode from the LP mode, transmitter 120 starts high-speed data transmission (HSDT), sets the lock register value as 1, and transmits the signal (LRV) that corresponds to the lock register value 1 to the receiver.

The receiver 220 recognizes the present transmission mode with the HS mode according to the lock register value 1 in the signal (LRV), and operates according to the HS mode as long as the lock register value is not changed. For example, the receiver 220 may recognize the current mode based on the lock register value regardless of noise. This differs from other systems, which switch the LP mode based on external noise. Therefore, in accordance with the present embodiment, receiver 220 determines the data received by HSDT as valid data according to the lock register value 1 in the signal (LRV).

When the mode is switched to LP mode from HS mode, the transmitter 120 sets the lock register value as 0 and transmits the signal (LRV) including the lock register value 0 to the receiver 220. The transmitter 120 starts low power data transmission (LPDT). The receiver 220 recognizes the LP mode according to the lock register value 0 in the signal (LRV), and determines the data received by LPDT to be valid data.

As described, in other embodiments, the lock register may be used to block external noise caused by ESD from the interface. In the above-described embodiments, the transmitter may be included in the set and the receiver may be included in the display.

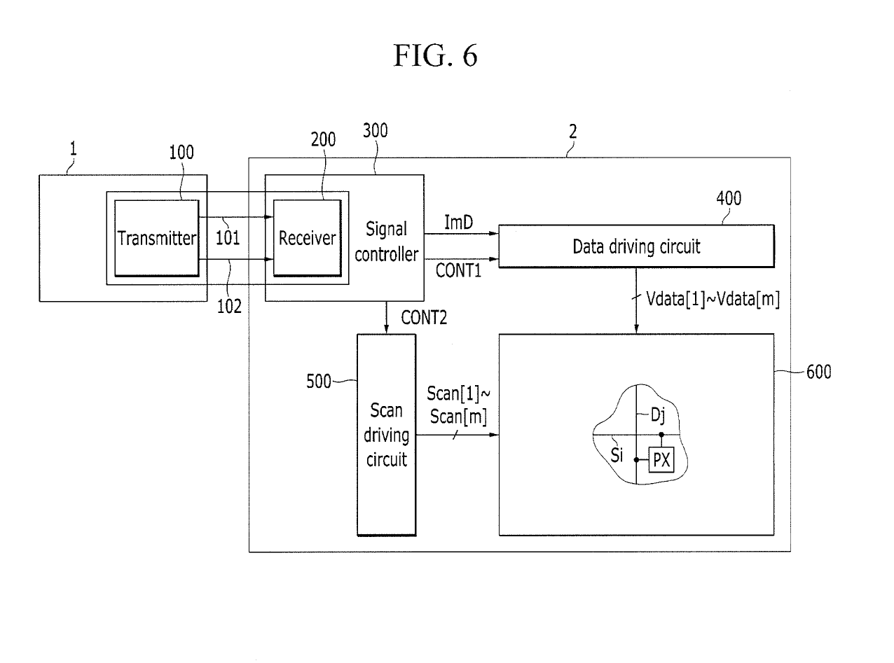

FIG. 6 shows a set and a display connected through an interface according to one embodiment. As shown in FIG. 6, a set 1 is connected to signal controller 300 of a display 2 through an interface 10. Data (DATA) and clock signals (DCLK) generated by the set 1 are transmitted to the signal controller 300 of display 2 through the interface 10. Instead of the interface 10 in FIG. 6, the interfaces 20 and 30 in FIG. 3 and FIG. 5 may be provided between the set 1 and the display 2.

The display 2 includes the signal controller 300, a data driving circuit 400, a scan driving circuit 500, and a display unit 600. The signal controller 300 generates an image data signal (ImD), a data driving control signal (CONT1), and a scan driving control signal (CONT2) according to image information and timing information from the receiver 200. The image data signal (ImD) is configured with data that indicate gray scale values of respective pixels according to image information.

The data driving circuit 400 generates a plurality of data voltages (Vdata[1]-Vdata[n]) according to the image data signal (ImD), and transmits the same to the display unit 600 according to the data driving control signal (CONT1).

The scan driving circuit 500 generates a plurality of scan signals (Scan[1]-Scan[n]) according to scan driving control signal (CONT2) and transmits the same to the display unit 600.

The display unit 600 includes a plurality of scan lines (e.g., Si), a plurality of data lines (e.g., Dj), and a plurality of pixels (e.g., PX). The data voltage (Vdata[j]), transmitted through a corresponding data line (Dj) during an enable period of the scan signal (Scan[i]) transmitted through a corresponding scan line (Si), is written on the pixel (PX).

The pixel (PX) emits light according to the written data voltage (Vdata[j]). The pixel may include an organic light emitting diode (OLED) element or liquid crystal element.

The signal controller 300 may receive the data (DATA) without interference of noise by ESD through various embodiments of the interfaces 10, 20, and 30 described herein, to thereby prevent deterioration of image quality of the display 2 by ESD.

By way of summation and review, a mobile industry processor interface standard for processing high-speed transmission of large capacity data with low power consumption between a display and a central processing unit has been proposed. When the display is driven and electrostatic discharge noise is applied to an MIPI clock signal, images may be stopped or broken. Also, when ESD is applied to an MIPI lane in HS mode operation, a display driving IC may switch to LP mode. However, the set may be operated in HS Mode, and thus does not communicate with the display driving IC. As a result, images may be stopped or broken.

In accordance with one or more of the aforementioned embodiments, one or more of these effects may be overcome by providing an interface which includes a transmitter for transmitting data and a clock signal through a data lane and a clock signal lane. The transmitter periodically inserts an entering sequence into the clock signal. The transmitter may insert the HSDT entering sequence into at least one porch period of the clock signal. The clock signal includes first and second clock signals. The entering sequence may include one or more periods distinguishable by a combination of a level of the first clock signal and a level of the second clock signal. A receiver receives the data and clock signal.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An interface, comprising:
a transmitter to transmit data and a clock signal through a data lane and a clock signal lane, respectively; and
a receiver to receive the data and clock signal, wherein the transmitter is to periodically insert a high speed data transmission (HSDT) entering sequence into the clock signal.

2. The interface as claimed in claim 1, wherein the transmitter is to insert the HSDT entering sequence into a porch period of the clock signal.

3. The interface as claimed in claim 2, wherein:
the clock signal includes first and second clock signals, and
the HSDT entering sequence includes periods distinguishable by a combination of a level of the first clock signal and a level of the second clock signal.

4. The interface as claimed in claim 3, wherein:
the HSDT entering sequence includes a plurality of periods distinguishable by a combination of a first level of the first clock signal and a first level of the second clock signal, a second level of the first clock signal and the first level of the second clock signal, and the second level of the first clock signal and a second level of the second clock signal.

5. An interface, comprising:
a transmitter to transmit data and a clock signal through a data lane and a clock signal lane, respectively; and
a receiver to receive the data and clock signal, wherein the receiver is to transmit an error signal that corresponds to a detected status error to the transmitter, and the transmitter is to insert a high speed data transmission (HSDT) entering sequence into the clock signal when detected by the error signal.

6. The interface as claimed in claim 5, wherein
the clock signal includes first and second clock signals, and
the HSDT entering sequence includes periods distinguishable by a combination of a level of the first clock signal and a level of the second clock signal.

7. The interface as claimed in claim 6, wherein
the HSDT entering sequence includes a plurality of periods distinguishable by a combination of a first level of the first clock signal and a first level of the second clock signal, a second level of the first clock signal and the first level of the second clock signal, and the second level of the first clock signal and a second level of the second clock signal.

8. An interface, comprising:
a transmitter to set a lock register to indicate one of a high speed mode or a low power mode, and to transmitting the lock register value with data and a clock signal through a data lane and a clock signal lane, respectively; and
a receiver to receive the data and clock signal, to recognize a transmission mode according to the lock register value, and to determine validity of the received data.

9. The interface as claimed in claim 8, wherein:
when switching to the high speed mode from the low power mode, the transmitter is to start high-speed data transmission, set the lock register value to a value indicating the high-speed mode, and transmit a signal corresponding to the predetermined lock register value to the receiver.

10. The interface as claimed in claim 9, wherein the receiver is to:
recognize the high-speed mode according to a signal corresponding to the predetermined lock register value, and
determine the data received by the high-speed data transmission to be valid data.

11. The interface as claimed in claim 8, wherein:
when switching to the low power mode from the high-speed mode, the transmitter is to set the lock register value to be a value indicating the low power mode, and to transmit a signal that corresponds to the predetermined lock register value to the receiver.

12. The interface as claimed in claim 11, wherein the receiver is to:
recognize the low power mode according to a signal corresponding to the predetermined lock register value, and
determine that the data received by the low power data transmission is valid data.

13. A display for receiving data and a clock signal from a set through an interface, the display comprising:
a signal controller to generate an image data signal and a data driving control signal from the data and clock signal; and
a data driving circuit to generate a plurality of data voltages based on the image data signal and data driving control signal, wherein the clock signal includes a high speed data transmission (HSDT) entering sequence.

14. The display as claimed in claim 13, wherein the HSDT entering sequence is periodically inserted into the clock signal.

15. The display as claimed in claim 13, wherein:
the signal controller includes a receiver to transmit an error signal corresponding to the detected status error to a transmitter of the interface, and
the HSDT entering sequence is inserted into the clock signal when the error signal is transmitted.

16. An interface, comprising:
a transmitter to transmit data and a clock signal through a data lane and a clock signal lane, respectively, wherein:
the transmitter is to insert an entering sequence into the clock signal,
the clock signal includes first and second clock signals, and
the entering sequence includes periods distinguishable based on levels of the first clock signal and second clock signal in each of the periods.

17. The interface as claimed in claim 16, wherein the clock signals form a differential clock signal.

18. The interface as claimed in claim 16, wherein the first and second clock signals have a same level in a first section of a porch period and different levels in a second section of a porch period.

19. The interface as claimed in claim 18, wherein the second section of the porch period is longer than the first section of the porch period.

20. The interface as claimed in 16, wherein the entering sequence is a high-speed data transmission entering sequence.
